(19) United States
(12) Patent Application Publication
(10) Pub. No.: US 2008/0040615 A1
(43) Pub. Date: Feb. 14, 2008

(54) BIOMETRIC EMBEDDED DEVICE

(75) Inventors: Todd Alan Carper, San Francisco, CA (US); Michael D. Gardiner, San Diego, CA (US)

Correspondence Address: PAUL, HASTINGS, JANOFSKY & WALKER LLP, 875 15th Street, NW, Washington, DC, 20005, US

(73) Assignee: ELECTRONIC PLASTICS, LLC, Las Vegas, NV (US)

(21) Appl. No.: 11/771,993

(22) Filed: Jun. 29, 2007

Related U.S. Application Data
(60) Provisional application No. 60/806,494, filed on Jul. 3, 2006.
(60) Provisional application No. 60/806,433, filed on Jun. 30, 2006.

(51) Int. Cl. H04L 9/32

(52) U.S. Cl. 713/186

(57) ABSTRACT

A biometric device, in one embodiment, comprising an interface for communicating with a device reader; a first processor coupled to the interface; a biometric acquisition device coupled to the first processor; a switch coupled to the interface; and a second processor coupled to the interface through the switch. A method, in one embodiment, comprising receiving power at a first processor within an embedded biometric device; authenticating a user of the embedded biometric device; activating a switch in response to the authentication of the user in order to provide power and input/output to a second processor within the embedded biometric device.

This application claims priority to U.S. Provisional Patent Application No. 60/806,433, filed Jun. 30, 2006, entitled BIOMETRIC EMBEDDED DEVICE, which application is incorporated herein by reference in its entirety. This application also claims priority to U.S. Provisional Patent Application No. 60/806,494, filed Jul. 3, 2006, entitled BIOMETRIC EMBEDDED DEVICE, which application is incorporated herein by reference in its entirety.

### BACKGROUND OF THE INVENTION

1. Field of the Invention

The present invention relates to embedded devices. More specifically, the present invention relates to biometric embedded devices that authenticate the identity of a user of the biometric embedded device.

2. Discussion of the Related Art

Biometric SmartCards are known in the art. For example, one biometric SmartCard is disclosed in U.S. Patent Application No. 2004/0129787, published Jul. 8, 2004, to Saito et al., entitled SECURE BIOMETRIC VERIFICATION OF IDENTITY. The biometric SmartCard includes both an International Standards Organization (ISO) processor and a security processor. The ISO processor handles the SmartCard functions and the security processor is used to perform identity verification functions. In general, the ISO processor is a very secure integrated circuit and the security processor is much less secure. In this manner, the operation and data stored on the security processor can be readily accessed by someone with the proper equipment. Upon insertion into a SmartCard reader the security processor and the ISO processor are both powered by the SmartCard reader. At this point, the ISO processor and the security processor can potentially transmit data to the card reader before a user of the SmartCard has been authenticated.

### SUMMARY OF THE INVENTION

The present embodiments provide for a biometric embedded device including means for preventing unauthorized use of the biometric embedded device.

One embodiment can be characterized as a biometric device comprising an interface for communicating with a device reader; a first processor coupled to the interface; a biometric acquisition device coupled to the first processor; a switch coupled to the interface; and a second processor coupled to the interface through the switch.

Another embodiment can be characterized as a biometric device comprising an interface for communicating with a device reader; a switching matrix coupled to the interface; a first processor coupled to the interface through the switching matrix; a biometric acquisition device coupled to the first processor; and a second processor coupled to the interface through the switching matrix.

A subsequent embodiment includes a method comprising receiving power at a first processor within an embedded biometric device; authenticating a user of the embedded biometric device; and activating a switch in response to the authentication of the user in order to provide power and input/output to a second processor within the embedded biometric device.

Yet another embodiment can be characterized as a method comprising receiving power at a first processor within an embedded biometric device; receiving power at a second processor within the embedded biometric device; providing input/output between the first processor and the second processor; authenticating a user of the embedded biometric device at the second processor; and activating a switch in response to the authentication of the user in order to provide input/output between the second processor and a device reader.

Still another embodiment includes a method comprising receiving power from a device reader at a first processor within an embedded biometric device; acquiring biometric data from a biometric reader that is coupled to the first processor; controlling the activation of a switching matrix from the first processor to provide power to a second processor within the embedded biometric device and to provide input/output between the first processor and the second processor; receiving power from the device reader at the second processor; authenticating a user of the embedded biometric device at the second processor by comparing the acquired biometric data to reference biometric data stored at the second processor; communicating an authentication message from the second processor to the first processor; and controlling the activation of the switching matrix from the first processor in response to the receipt of the authentication message in order to provide input/output between the second processor and the device reader.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a block diagram illustrating a biometric embedded device system in accordance with one embodiment;

FIG. 2 is a block diagram illustrating a biometric embedded device system in accordance with an alternative embodiment;

FIG. 3 is a block diagram illustrating a biometric embedded device system in accordance with yet an alternative embodiment;

FIG. 4 is a block diagram illustrating a biometric embedded device system in accordance with yet another embodiment;

FIG. 5 is a flow diagram illustrating a method of operating a biometric embedded device in accordance with one embodiment;

FIG. 6 is a flow diagram illustrating a method of operating a biometric embedded device in accordance with another embodiment; and

FIG. 7 is a flow diagram illustrating a method of operating a biometric embedded device in accordance with yet another embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

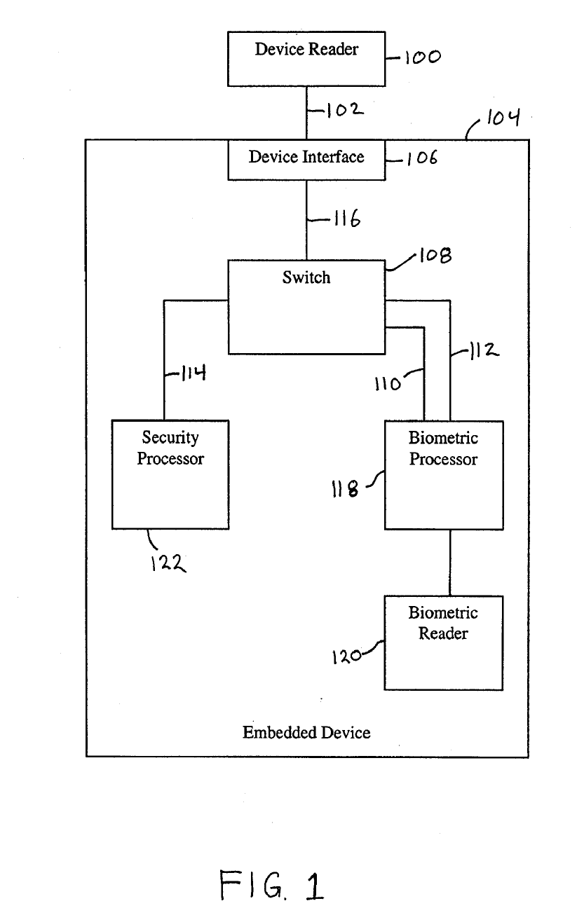

Referring to FIG. 1, a block diagram is shown illustrating a biometric embedded device system in accordance with one embodiment. Shown is a device reader 100, an interface 102, an embedded device 104, an embedded device interface 106, a switch 108, a control line 110, a first communication and power line 112, a second communication and power line 114, a third communication and power line 116, a biometric processor 118, a biometric reader 120 and a security processor 122.

The device reader 100 communicates with the embedded device 104 over the interface 102. The interface 102 provides input/output (I/O) functions between the embedded device 104 and the device reader 100 and also provides power from the device reader 100 to the embedded device 104. The interface 102 can be a wired or wireless interface such as is known to one of ordinary skill in the art.

The device reader 100 is a device terminal that is used to communicate with the embedded device. The device terminal can be, for example, a SmartCard reader. The device reader 100 can be utilized for many different applications, such as, for example, financial transactions, authorization for entry, identification, or many other types of applications.

The embedded device 104 is, for example, a SmartCard, a USB flash card, or other type of portable integrated circuitry that is embedded within or mounted on a casing and capable of communicating with the device reader 100. In an alternative embodiment, the embedded device 104 includes integrated circuitry that is coupled to a flexible substrate (e.g., a bracelet or watch band) and/or a wearable device, such as, for example, a watch, necklace or badge. In one embodiment described, the security processor is implemented as a true computer processor including an operating system as compared to most implementations where the security processor is implemented as a passive state device. U.S. Provisional Patent Application No. 60/734,793, filed Nov. 9, 2005, to Carper, entitled TOKEN COMPUTER PROVIDING A SECURE WORK ENVIRONMENT AND UTILIZING A VIRTUAL INTERFACE, which is incorporated herein by reference in its entirety, describes various embodiments for implementing the security processor as a true computer processor. As described herein, the security processor 122 is implemented in either way depending upon the nature of the application in which the embedded device 104 is being utilized.

In most applications, the embedded device 104 will receive power from the device reader 100. Alternatively, the embedded device is powered by an internal battery or other on board energy source. It should be understood that the size, shape, nature and composition of the material of the casing used for mounting the integrated circuit are not limited to a SmartCard, but can be many other forms in accordance with alternative embodiments.

The embedded device 104 includes the switch 108 which is coupled to the embedded device interface 106, the biometric processor 118 and the security processor 122. The switch (also referred to herein as a switching matrix) is, for example, one or more electrical, mechanical or logical switches that allow for various connections to be engaged or disengaged. The embedded device interface 106 provides for receipt of power and I/O functions from the device reader. For example, a SmartCard has a metal contact that acts as the embedded device interface 106 to a SmartCard reader. Alternatively, the embedded device interface 106 includes an antenna for wireless applications. The biometric processor 118 is also coupled to the biometric reader 120 (also referred to herein as a biometric acquisition device). The biometric reader 120, in accordance with one embodiment is a fingerprint sensor; however, other types of readers or sensors are utilized in alternative embodiments. U.S. Patent Publication No. 2004/0129787, filed Jul. 8, 2004, to Saito et al., entitled SECURE BIOMETRIC VERIFICATION OF IDENTITY, which is incorporated herein by reference in its entirety, discloses a biometric reader 120 that can be utilized in accordance with one embodiment of the present invention.

The biometric processor 118, in the present embodiment, operates to validate the identity of a user of the embedded device 104. Additionally, the biometric processor 118 controls the operation of the switch 108 through the control line 110. In one embodiment, the biometric processor 118 is a general purpose processor. The security processor 122 is a secure processor that operates to perform the functions of the application the embedded device is designed to carry out. For example, the security processor performs the functions necessary to carry out a financial transaction, provide access to a building or any other application. The security processor 122 is a secure processor that is manufactured such that data and any applications located on the security processor 122 can not be readily accessed. Such methods of manufacturing a secure processor are known to those of ordinary skill in the art. In general, a secure processor is much more expensive as compared to a normal processor (e.g., the biometric processor 118 described herein). While the biometric processor 118 can be made as a secure processor, in general, this will add greatly to the cost of the embedded device. Thus, for many applications it is not practical to have the biometric processor 118 be a secure processor. As described herein a processor is a circuit or circuitry including, for example, either dedicated or fixed purpose hardware and/or a partially or fully programmable platform. Additionally, as described herein, a processor can include hardware, firmware, and/or software functioning alone or in combination. In one embodiment, the processor includes an operating system and memory for storing one or more executable applications. One example, of a processor including an operating system and executable application is described in U.S. Pat. No. 6,390,374, issued May 21, 2002, to Carper et al., entitled SYSTEM AND METHOD FOR INSTALLING/DE-INSTALLING AN APPLICATION ON A SMART CARD, which patent is incorporated herein by reference in its entirety.

In operation, when the embedded device 104 is connected to the device reader 100, power is provided to the embedded device 104 over the interface 102. By default on start-up, the switch 108 is connected between the first communication and power line 112 and the third communication and power line 116. Thus, power is provided to the biometric processor 118 through the switch 108. The I/O functionality between the biometric processor 118 and the device reader 100 is optionally also connected, however, is not necessary in many embodiments. It should be understood by one of ordinary skill in the art that the each of communication and power lines can be one or more electrical conductors that are used to provide at least power and I/O functionality between the device reader 100, the biometric processor 118 and the security processor 122.

After receiving power from the device reader 100, the biometric processor 118 attempts to validate a user of the embedded device 104. First, the biometric processor 118 acquires biometric data from the biometric reader 120. For example, the biometric processor 118 will attempt to acquire fingerprint data from the biometric reader 120. After obtaining the biometric data, the biometric processor 118 performs a validation of the user by comparing the biometric data to reference biometric data stored within memory of the biometric processor 118 or memory coupled to the biometric processor 118. In one example, in order to validate the user, the biometric data must match the reference biometric data within a predetermined threshold. In one embodiment, a fingerprint sensor captures fingerprint data for a user currently holding the embedded device 104 and compares the captured fingerprint data to reference fingerprint data stored in a memory of the embedded device 104. If the biometric processor 118 can not validate the user, the security processor 122 will remain without power. In this manner, the embedded device 104 will be unable to perform its intended application and unauthorized use of the embedded device 104 is prevented.

However, upon validating the user of the embedded device 104, the biometric processor 118 sends a control signal to the switch 108 over the control line 110. The control signal causes the switch to connect the second communication and power line 114 to the third communication and power line 116. The power to the biometric processor 118 is preferably terminated, however, remains connected for some embodiments. Upon being provided power, the security processor 122 will send an answer to reset (ATR) to the device reader 100. The device reader 100 and the security processor 122 then proceed to perform the intended application of the embedded device 104 (e.g., a financial transaction or validation of identity for entry). In this manner, the security processor 122 operates without the knowledge that the biometric processor 118 performed a validation. The present embodiment can be used to easily modify an embedded device in order to incorporate biometric identity validation without changing the functionality of the security processor 122. In this manner, the security processor 122 can function independently from the biometric processor 118.

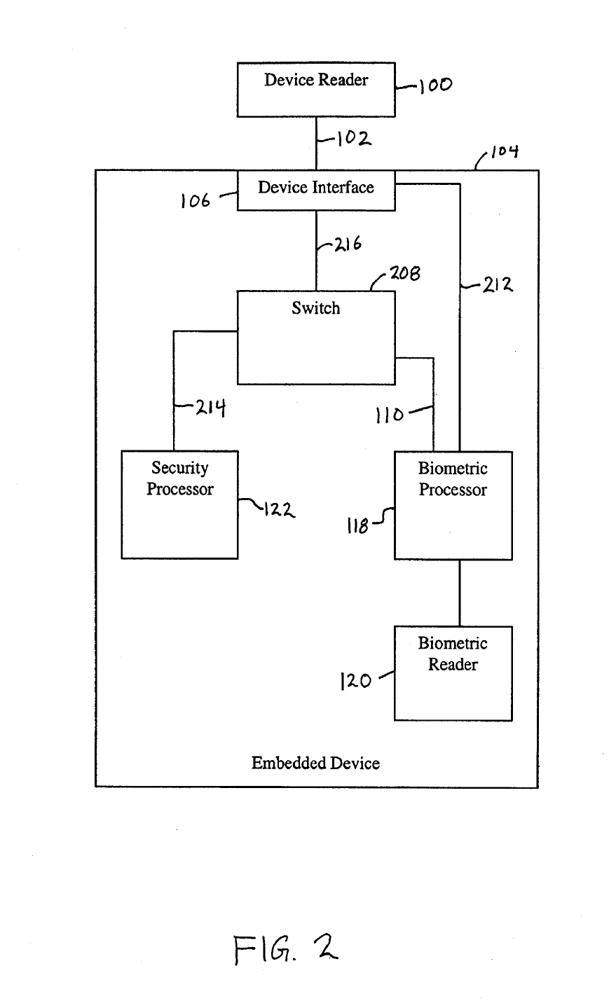

Referring now to FIG. 2, a block diagram is shown illustrating a biometric embedded device system in accordance with an alternative embodiment. Shown is the device reader 100, the interface 102, the embedded device 104, the embedded device interface 106, a switch 208, the control line 110, a first power line 212, a first communication and power line 214, a second communication and power line 216, the biometric processor 118, the biometric reader 120 and the security processor 122.

The present embodiment is similar to the embodiment described above in FIG. 1; however, the biometric processor 104 is not coupled to the device reader 100 through the switch 208. In this manner, the biometric processor 104 will receive power so long as the biometric processor 104 is coupled to the device reader 100.

In operation, when the embedded device 104 is coupled to the device reader 100, the biometric processor 118 is provided power. By default, the switch 208 is left open, thus, the security processor 122 is not powered on. I/O functionality between the biometric processor 118 and the device reader 100 is optionally connected, however, is not necessary. Preferably, only one processor is connected to the I/O from the device reader 100 at a time in order to prevent errors in communication. Thus, when desired, the biometric processor 118 preferably has the I/O functionality connected through the switch 208 such that the I/O functionality can be disconnected after the security processor 122 is powered and connected to the device reader 100.

After receiving power from the device reader 100, the biometric processor 118 attempts to validate a user of the embedded device 104 by obtaining a reading from the biometric reader 120. After obtaining biometric data from the biometric reader 120, the biometric processor 118 performs the validation by comparing the biometric data to reference biometric data stored within memory of the biometric processor 118 or memory coupled to the biometric processor 118. If the biometric processor 118 can not validate the user, the security processor 122 will remain without power. In this manner, the embedded device 104 will be unable to perform its intended application and unauthorized use of the embedded device 104 is prevented.

However, upon validating the user of the embedded device 104, the biometric processor 118 sends a control signal to the switch 208 over the control line 110. The control signal causes the switch to connect the first communication and power line 214 to the second communication and power line 216. Upon being provided power, the security processor 122 will send an answer to reset (ATR) to the device reader 100. The device reader 100 and the security processor 122 then proceed to perform the intended application of the embedded device 104. In this manner, the security processor 122 operates without the knowledge that the biometric processor 118 performed a validation.

In the embodiment described with reference to FIG. 2, power to the biometric processor 118 remains on the entire time the embedded device 104 is coupled to the device reader 100. In an application where the interface 102 is a wired interface providing power to the biometric processor 118 is not much of a concern. However, when the interface 102 is a wireless interface, power is at more of a premium, and thus, it may be desirable to cut power to the biometric processor 118 such as can be done in the embodiment shown in FIG. 1.

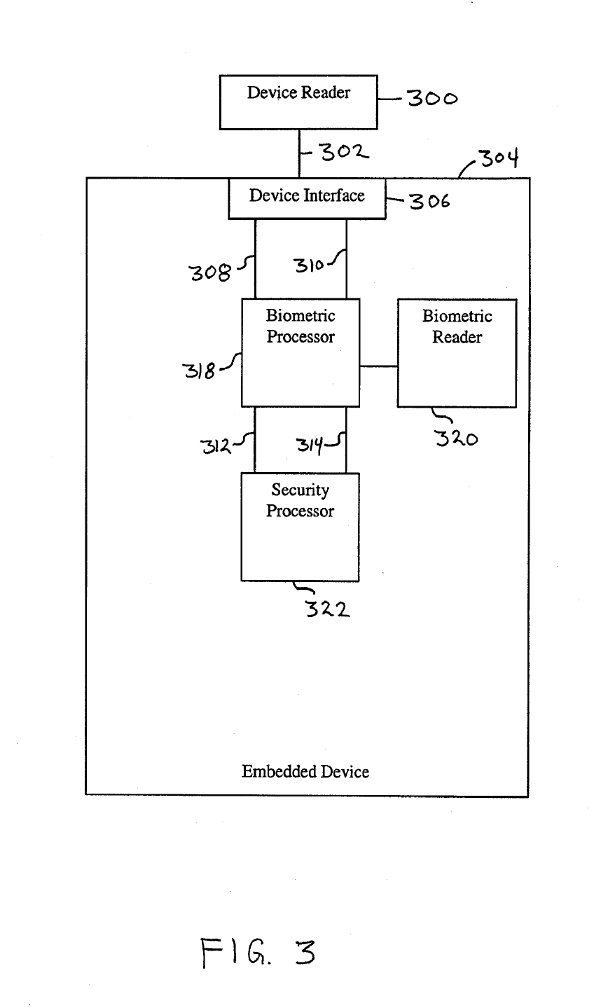

Referring next to FIG. 3, a block diagram is shown illustrating a biometric embedded device system in accordance with yet an alternative embodiment. Shown is a device reader 300, an interface 302, an embedded device 304, an embedded device interface 306, a first power line 308, a first communication line 310, a second power line 312, a second communication line 314, a biometric processor 318, a biometric reader 320 and a security processor 322.

The biometric processor 318 is coupled to the device reader 302 through the first power line 308 and the first communication line 310. Additionally, the biometric processor 318 is coupled to the biometric sensor 320 and the security processor 322. In operation, the biometric processor 318 receives power from the device reader 300 over the first power line 308. After receiving power from the device reader 300, the biometric processor 318 attempts to validate a user of the embedded device 304 by obtaining a reading from the biometric reader 320. After obtaining biometric data from the biometric reader 320, the biometric processor 318 performs the validation by comparing the biometric data to reference biometric data stored within memory of the biometric processor 318 or memory coupled to the biometric processor 318. If the biometric processor 318 can not validate the user, the security processor 322 will remain without power. In this manner, the embedded device 304 will be unable to perform its intended application and unauthorized use of the embedded device 304 is prevented.

However, upon validating the user of the embedded device 304, the biometric processor 318 provides power to the security processor 322 over the second power line 312. The security processor 322 communicates with the biometric processor 318 over the second communication line 314. The device reader 300 and the security processor 322 then proceed to perform the intended application of the embedded device 304 with the biometric processor 318 functioning to direct communications between the device reader 300 and the security processor 322. In the present embodiment, the biometric processor 318 will have additional programming requirements to control the communications between the device reader 300 and the security processor 322. Additionally, the biometric processor 318 must remain powered on in order for the security processor 322 to communicate with the device reader 300.

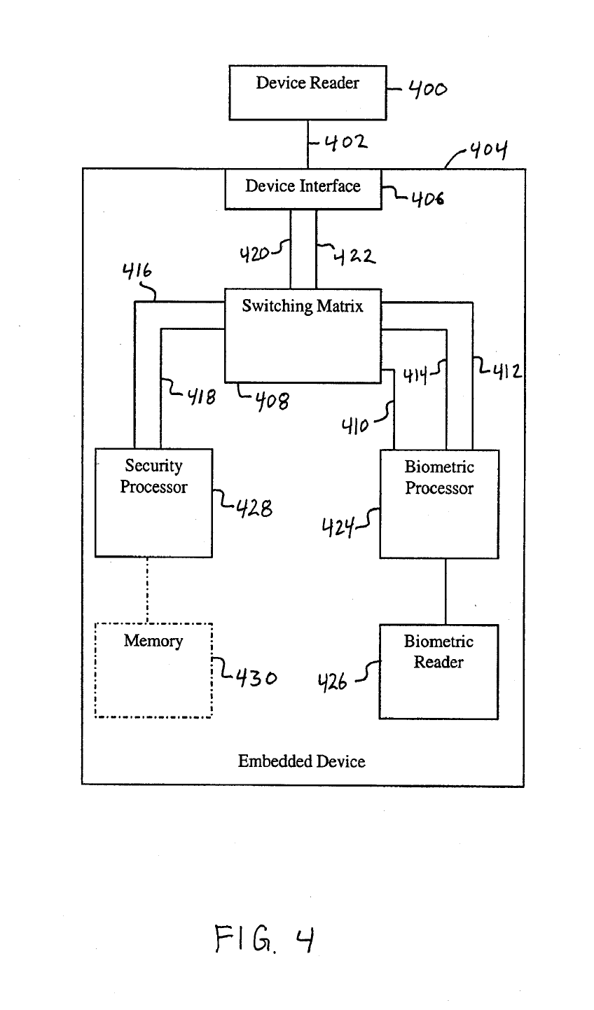

Referring to FIG. 4, a block diagram is shown illustrating a biometric embedded device system in accordance with yet another embodiment. Shown is a device reader 400, an interface 402, an embedded device 404, an embedded device interface 406, a switching matrix 408, a control line 410, a first communication line 412, a first power line 414, a second communication line 416, a second power line 418, a third communication line 420, a third power line 422, a biometric processor 424, a biometric reader 426, a security processor 428 and a memory 430.

The switching matrix 408 is coupled to the first communication line 412, the first power line 414, the second communication line 416, the second power line 418, the third communication line 420, and the third power line 422. The switching matrix allows for various connections to be made including connecting power from the third power line 422 to either the first power line 414 or the second power line 416. Additionally, the second communication line 418 can be connected to either the first communication line 414 or the third communication line 422. Other connections can also be made in various embodiments. In this manner, the security processor 428 can communicate with each of the biometric processor 424 and the device reader 400 depending upon the setting of the switching matrix 408. The switching matrix 408 is controlled by the biometric processor 424 through the control line 410.

In operation, when the embedded device 404 is connected to the device reader 400, power is supplied to the biometric sensor 424. By default on start-up, the switching matrix 408 will connect the first power line 412 to the third power line 420. After receiving power from the device reader 400, the biometric processor 424 obtains a reading from the biometric reader 426. After obtaining biometric data from the biometric reader 426, the biometric processor 424 activates the switching matrix to provide power to the security processor 416 and connects the first communication line 414 to the second communication line 418 such that the biometric processor 424 can communicate with the security processor 428. Alternatively, the default of the switching matrix provides power to the biometric processor 424 and the security processor 428 and connects the first communication line 414 to the second communication line 418. Following, the biometric data being obtained from the biometric reader 426, the biometric data is sent to the security processor 428 to perform a validation by comparing the biometric data to reference biometric data stored within memory of the security processor 428. By storing the reference biometric data on memory of the security processor 428 and performing the validation on the security processor 428, the validation process is more secure as compared to when the validation is performed on a non-secure processor. If the security processor 428 can not validate the user, the I/O functions between the security processor 428 and the device reader 400 will never be connected. In this manner, the embedded device 404 will be unable to perform its intended application and unauthorized use of the embedded device 404 is prevented.

However, upon validating the user of the embedded device 404, the security processor 428 communicates a successful validation to the biometric processor 424 over the first communication line 414 and the second communication line 418. Upon receiving confirmation of a successful validation, the biometric processor 424 sends a control signal to the switching matrix 408 to connect the second communication line 418 to the third communication line 422. The device reader 400 and the security processor 428 then proceed to perform the intended application of the embedded device 404. At this time, the biometric processor 424 can optionally send a control signal to the switching matrix to disconnect the first power line 414 from the third power line 420, thus, turning off the biometric processor 424. In one embodiment, it is important that the security processor 428 does not lose power once it is activated by the biometric processor 424. When the security processor 428 validates the biometric data, the validation result is kept in the RAM of the security processor 428. If power is lost, the validation result is lost. Prior to performing the actual application contained in the security processor 428 a test is performed to ensure that there is a validation result in RAM. This safeguard is in place to ensure that an attacker does not simply apply power and IO directly to the security chip and attempt to utilize the security chip without first presenting the biometric data and getting a positive validation result.

In one embodiment, the security processor 428 is coupled to the optional memory device 430. The memory device 430 is, for example, flash memory such as the memory that is used in Universal Serial Bus (USB) Flash Drives. In a preferred embodiment, the data stored on the memory device is encrypted by the security processor 428. Furthermore, in one embodiment, the security processor 428 is the only device capable of decrypting the data in the memory device. In this manner, the data stored in the memory device is highly secure. The data stored in the memory device can be sensitive files or personal information such as health care information or financial information. The memory 430 can also be included, in a SmartCard implementation and used to store personal or sensitive information that is to be used in completing, for example, a transaction with the device reader 400. It should be understood that the memory device 430 can optionally be incorporated into any of the embodiments described herein, including, for example, the embodiments described with reference to FIGS. 1-3. Additionally, in some embodiments, the memory device 430 can be coupled to the biometric processor 424 and access to the memory is then controlled by the biometric processor 424.

In operation, after the security processor 428 or the biometric processor 424 (in some the embodiments described above) authenticates a user of the embedded device 404, the security processor 428 will access and possible decrypt the data stored in the memory device 430 as needed for the specific application the embedded device 404 is being utilized for. The security processor can, for example, send encrypted data to the device reader 400 or can decrypt the data stored in the memory 430 and send the decrypted data to the device reader 400. In this manner, the security processor 428 controls access to any data stored in the memory 430.

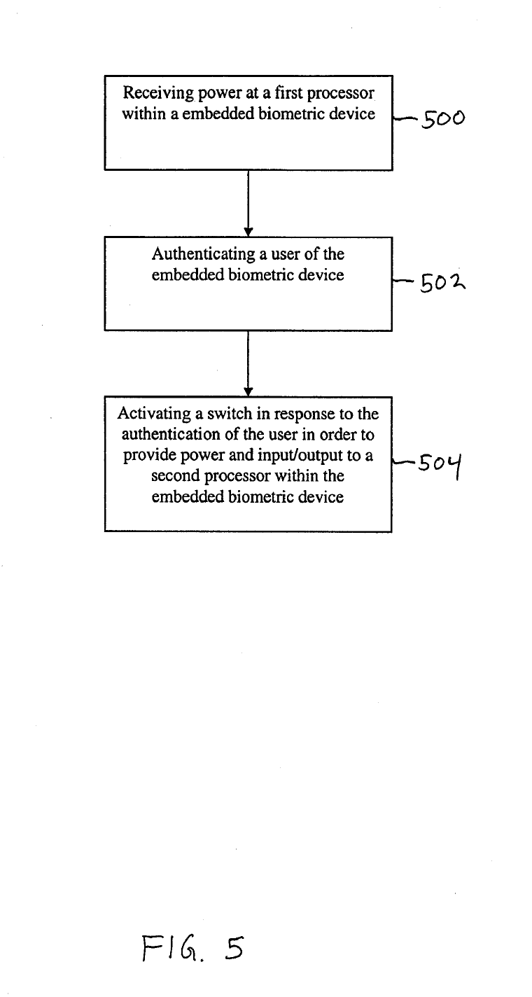

Referring to FIG. 5, a flow diagram is shown illustrating a method of operating a biometric embedded device in accordance with one embodiment.

In step 500, a first processor within an embedded biometric device receives power. The embedded biometric device receives power from either a device reader or an onboard energy source such as a battery. Following in step 502, a user of the embedded biometric device is authenticated. Many different methods of authenticating can be performed within the embedded biometric device.

In step 504, a switch is activated in response to the authentication of the user in order to provide power and input/output to a second processor within the embedded biometric device. After power and input/output functions have been enabled for the second processor, a device reader and the second processor can communicate and perform any number of various applications (e.g., a financial transaction).

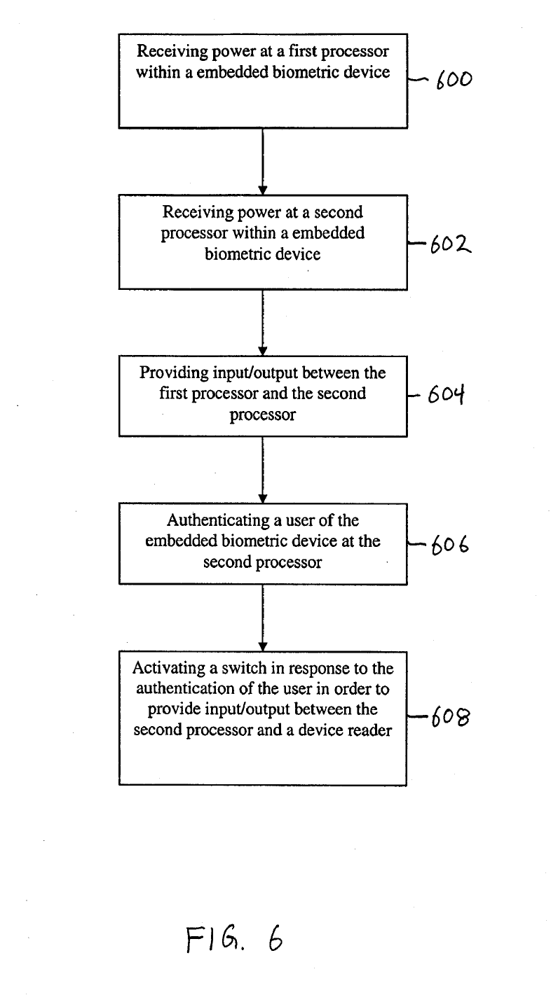

Referring to FIG. 6, a flow diagram is shown illustrating a method of operating a biometric embedded device in accordance with one embodiment.

In step 600, power is received at a first processor within an embedded biometric device. The embedded biometric device receives power from either a device reader or an onboard energy source such as a battery. In step 602, power is received at a second processor within an embedded biometric device. Power for the second processor can be provided, for example, directly from a device reader, by routing from the device reader through the first processor or by routing through the first processor from an onboard energy source.

In step 604, input/output function is provided between the first processor and the second processor. In one embodiment, the first processor provides the second processor with biometric data received from a biometric sensor.

In step 606, a user of the embedded biometric device is authenticated by the second processor. In one embodiment, the second processor compares biometric data received from the first processor to reference biometric data stored in a memory accessible by the second processor.

In step 608, a switch is activated in response to the authentication of the user in order to provide input/output between the second processor and a device reader. After input/output functions have been enabled for the second processor, the device reader and the second processor can communicate and perform any number of various applications (e.g., a financial transaction).

Referring next to FIG. 7, a flow diagram is shown illustrating a method of operating a biometric embedded device in accordance with one embodiment.

In step 700, power from a device reader is received at a first processor within an embedded biometric device. In step 702, biometric data is acquired from a biometric reader that is coupled to the first processor. For example, a fingerprint is read at the biometric reader and fingerprint data corresponding to the fingerprint is generated.

In step 704, the activation of a switching matrix is controlled from the first processor to provide power to a second processor within the embedded biometric device and to provide input/output between the first processor and the second processor. Following, in step 706, power from the device reader is received at the second processor.

In step 708, a user of the embedded biometric device is authenticated at the second processor by comparing the acquired biometric data to reference biometric data stored at the second processor. In step 710, an authentication message is communicated from the second processor to the first processor. Next, in step 712, the activation of the switching matrix is controlled from the first processor in response to the receipt of the authentication message in order to provide input/output between the second processor and the device reader. After input/output functions have been enabled for the second processor, a device reader and the second processor can communicate and perform any number of various applications (e.g., a financial transaction). The communication between the device reader and the second processor may begin, for example, with an ATR being sent from the second processor to the device reader.

It should be understood that the methods described above in FIGS. 5-7 can include, in some embodiments, additional optional steps that may be desirable in commercially viable embodiments.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A biometric device comprising:
an interface for communicating with a device reader;
a first processor coupled to the interface;
a biometric acquisition device coupled to the first processor;
a switch coupled to the interface; and
a second processor coupled to the interface through the switch.

2. The biometric device of claim 1 wherein the switch is at least one of a logical switch implemented in the first processor, a physical switch, or an electrical switch.

3. The biometric device of claim 1 further comprising a memory device coupled to at least one of the first processor and the second processor.

4. The biometric device of claim 1 wherein the first processor is coupled to the interface through the switch.

5. The biometric device of claim 4 wherein the interface is one of a wired interface and a wireless interface.

6. The biometric device of claim 1 wherein the embedded device comprises one of a smart card, a USB drive, a flexible substrate and a wearable device.

7. The biometric device of claim 1 wherein the first processor authenticates a user upon receiving biometric data from the biometric acquisition device.

8. The biometric device of claim 7 wherein the first processor activates the switch upon authentication of the user and wherein power and input/output is provided to the second processor upon activation of the switch.

9. The biometric device of claim 1 wherein the second processor authenticates a user upon receiving biometric data acquired by the biometric acquisition device.

10. The biometric device of claim 9 wherein the first processor activates the switch after authentication of the user by the second processor and wherein input/output is provided between the device reader and the second processor upon activation of the switch.

11. A biometric device comprising:
an interface for communicating with a device reader;
a switching matrix coupled to the interface;
a first processor coupled to the interface through the switching matrix;
a biometric acquisition device coupled to the first processor; and
a second processor coupled to the interface through the switching matrix.

12. The biometric device of claim 11 wherein the first processor authenticates a user upon receiving biometric data from the biometric acquisition device.

13. The biometric device of claim 12 wherein the first processor activates the switching matrix upon authentication of the user and wherein power and input/output is provided to the second processor upon activation of the switching matrix.

14. The biometric device of claim 11 wherein the second processor authenticates a user upon receiving biometric data acquired by the biometric acquisition device.

15. The biometric device of claim 14 wherein the first processor activates the switching matrix after authentication of the user by the second processor and wherein input/output is provided between the device reader and the second processor upon activation of the switching matrix.

16. The biometric device of claim 11 wherein said switching matrix comprises at least three states, wherein said three states include:
(a) power and input/output coupled between the interface and the first processor;
(b) power and input/output coupled between the interface and the second processor; and
(c) power coupled to both the first processor and the second processor and input/output coupled between the first processor and the second processor.

17. The biometric device of claim 11 further comprising a memory device coupled to at least one of the first processor and the second processor.

18. The biometric device of claim 11 wherein the embedded device comprises one of a smart card, a USB drive, a flexible substrate and a wearable device.

19. The biometric device of claim 18 wherein the first processor receives biometric data from the biometric acquisition device and wherein the first processor activates the switching matrix to provide input/output between the first processor and the second processor.

20. The biometric device of claim 19 wherein the first processor sends the biometric data to the second processor and wherein the second processor compares the biometric data to reference biometric data for authentication of a user.

21. The biometric device of claim 20 wherein the second processor sends an authentication signal to the first processor after authentication of the user and wherein the first processor activates the switching matrix upon receipt of the authentication signal.

22. The biometric device of claim 21 wherein the activation of the switching matrix provides input/output between the second processor and the device reader.

23. A method comprising:
receiving power at a first processor within an embedded biometric device;
authenticating a user of the embedded biometric device; and
activating a switch in response to the authentication of the user in order to provide power and input/output to a second processor within the embedded biometric device.

24. The method of claim 23 further comprising:
acquiring biometric data from a biometric reader that is coupled to the first processor; and
comparing the biometric data acquired from the biometric reader with stored reference biometric data.

25. The method of claim 23 wherein the step of authenticating the user of the embedded biometric device further comprises:
comparing biometric data acquired from a biometric reader with stored reference biometric data; and
determining if the biometric the biometric data acquired from the biometric reader is within a predetermined tolerance of the stored reference biometric data.

26. A method comprising:
receiving power at a first processor within an embedded biometric device;
receiving power at a second processor within the embedded biometric device;
providing input/output between the first processor and the second processor;
authenticating a user of the embedded biometric device at the second processor; and
activating a switch in response to the authentication of the user in order to provide input/output between the second processor and a device reader.

27. The method of claim 26 further comprising:
acquiring biometric data from a biometric reader that is coupled to the first processor; and
comparing the biometric data acquired from the biometric reader with stored reference biometric data.

28. The method of claim 26 wherein the step of comparing the biometric data acquired from the biometric reader with stored reference biometric data is performed by the second processor.

29. The method of claim 26 wherein the step of authenticating the user of the embedded biometric device further comprises:
comparing biometric data acquired from a biometric reader with stored reference biometric data; and
determining if the biometric the biometric data acquired from the biometric reader is within a predetermined tolerance of the stored reference biometric data.

30. A method comprising:
receiving power from a device reader at a first processor within an embedded biometric device;
acquiring biometric data from a biometric reader that is coupled to the first processor;
controlling the activation of a switching matrix from the first processor to provide power to a second processor within the embedded biometric device and to provide input/output between the first processor and the second processor;
receiving power from the device reader at the second processor;
authenticating a user of the embedded biometric device at the second processor by comparing the acquired biometric data to reference biometric data stored at the second processor;
communicating an authentication message from the second processor to the first processor; and
controlling the activation of the switching matrix from the first processor in response to the receipt of the authentication message in order to provide input/output between the second processor and the device reader.

31. The method of claim 30 further comprising sending an answer to reset (ATR) message from the second processor to the device reader.

32. The method of claim 30 further comprising powering off the first processor after controlling the activation of the switching matrix to provide input/output between the second processor and the device reader.

33. The method of claim 30 further comprising removing the first processor from the input/output when controlling the activation of the switching matrix to provide input/output between the second processor and the device reader.

34. The method of claim 30 further comprising further comprising accessing data on a memory device after authenticating the user of the embedded biometric device.
